(19) United States
(12) Patent Application Publication
(10) Pub. No.: US 2015/0279364 A1
(43) Pub. Date: Oct. 1, 2015

(54) Mouth-Phoneme Model for Computerized Lip Reading

(71) Applicants: Ajay Krishnan, Portland, OR (US); Akash Krishnan, Portland, OR (US)

(72) Inventors: Ajay Krishnan, Portland, OR (US); Akash Krishnan, Portland, OR (US)

(21) Appl. No.: 14/229,910

(22) Filed: Mar. 29, 2014

(51) Int. Cl. G10L 15/25

(52) U.S. Cl. CPC G10L 15/25

(57) ABSTRACT

The invention described here uses a Mouth Phoneme Model that relates phonemes and visemes using audio and visual information. This method allows for the direct conversion between lip movements and phonemes, and furthermore, the lip reading of any word in the English language. Speech API was used to extract phonemes from audio data obtained from a database which consists of video and audio information of humans speaking a word in different accents. A machine learning algorithm similar to WEKA (Waikato Environment for Knowledge Analysis) was used to train the lip reading system.

### CROSS REFERENCE TO RELATED APPLICATIONS

This application is a conversion to a non-provisional application under 37 C.F.R. §1.53(c)(3) of U.S. provisional application No. 61/806,800, entitled “Mouth Phoneme Model for Computerized Lip Reading System”, filed on Mar. 29, 2013.

### BACKGROUND OF THE INVENTION

One of the most important components in any language is the phoneme. A phoneme is the smallest unit in the sound system of a language. There are 40 phonemes in English language. For example, the word ate contains the phoneme EY. Similarly, a viseme is the most basic level of mouth and facial movements that accompanies the production of phonemes. An important thing to note is that multiple phonemes can have the same viseme, as they can audibly be different, but visually can look the same. Some examples are the words power and shower. In 1976, researchers Harold McGurk and John McDonald published a paper called “Hearing Lips and Seeing Voices.” They discovered the McGurk effect, a relationship between vision and hearing in speech perception. They showed that we not only use our ears to listen to what people say, but also pay attention to their mouth movements.

Because of our ever growing reliance on technology, speech recognition systems have received a lot of interest to simplify human-computer interactions. However, audio-based speech recognition systems suffer from degraded performance due to imperfect real-world conditions, such as the presence of background noise in crowded areas. Computerized lip reading offers an alternative where background noise has no effect on the ability to recognize human speech. Lip reading is a difficult task for humans, and the results of one study showed that human lip reading is only 32% accurate.

Current methods of lip reading involve placing contours on lips to extract meaningful numerical information called features. However, only limited work has been done in lip reading in general. There are many factors that affect performance, ranging from lighting to facial hair, such as mustaches. Current researchers use PCA and Eigen values for feature extraction, which is computationally intensive, of the order O((H*W)³), where H and W represent the height and width of the image being processed respectively. Current lip reading systems have fairly low accuracies and are limited to vocabulary sets of short, easily distinguishable words. Our system scales very easily and can be used to decipher complex words.

### BRIEF SUMMARY OF THE INVENTION

The first step in developing the lip reading system involved recognizing the speaker's face in every video frame using a facial recognition algorithm in OpenCV2. After detecting the speaker's mouth region, key points were placed on the inner outline of the lips, which allowed for numerical feature extraction based on the changes in the positions of the speaker's lips over time. A total of 1.20 features were extracted, consisting of five coefficients generated from polynomial curve fitting of the lips, the 0th, 1st, and 2nd gradients, and four functional features consisting of the minimum, mean, maximum, and standard deviation of the lip key points. A novel mouth-phoneme model that relates phonemes and visemes using audio and visual information was developed, allowing for the direct conversion between hp movements and phonemes, and furthermore, the lip reading of any word in the English language. Microsoft's Speech API was used to extract phonemes from audio data in the database, and WEKA (Waikato Environment for Knowledge Analysis) was used to train the lip reading system. Overall, our lip reading system was 86% accurate based on databases obtained from different open source communities and university labs.

### BRIEF DESCRIPTION OF THE DRAWINGS

FIG. 1 is an illustration of computation blocks used during training phase that results in generation of a mouth phoneme model.

FIG. 2 is an illustration of computation blocks used during real time lip reading process.

FIG. 3 depicts the process of association of video frames to the phonemes present in the corresponding audio stream.

FIG. 4 shows the placement of key points for a typical human mouth in our lip reading process. These key points are automatically computed using the first 3 steps during training phase as described in FIG. 1 and during real time lip reading process as described in FIG. 2

FIG. 5 shows the feature values extracted from left, right, top and bottom key points for every video frame.

FIG. 6 shows the 0^{th} Gradient values of the extracted features for every video frame.

FIG. 7 shows the 1^{st} Gradient values of the extracted features for every video frame.

FIG. 8 shows the 2^{nd} Gradient values of the extracted features for every video frame.

FIG. 9 shows the evaluation of rotation matrix as part of the normalization process when speaker's lips are at an angle relative to horizontal.

FIG. 10 illustrates the scaling equation that is used to fix the aspect ratio of the lip contour.

FIG. 11 depicts the use of fourth degree polynomials determined in MATLAB to create lip contours for each frame. The coefficients and constant term of polynomials are used as features in feature extraction process.

FIG. 12 shows the normalized curve fitted lip contour for every frame.

### DESCRIPTION OF INVENTION

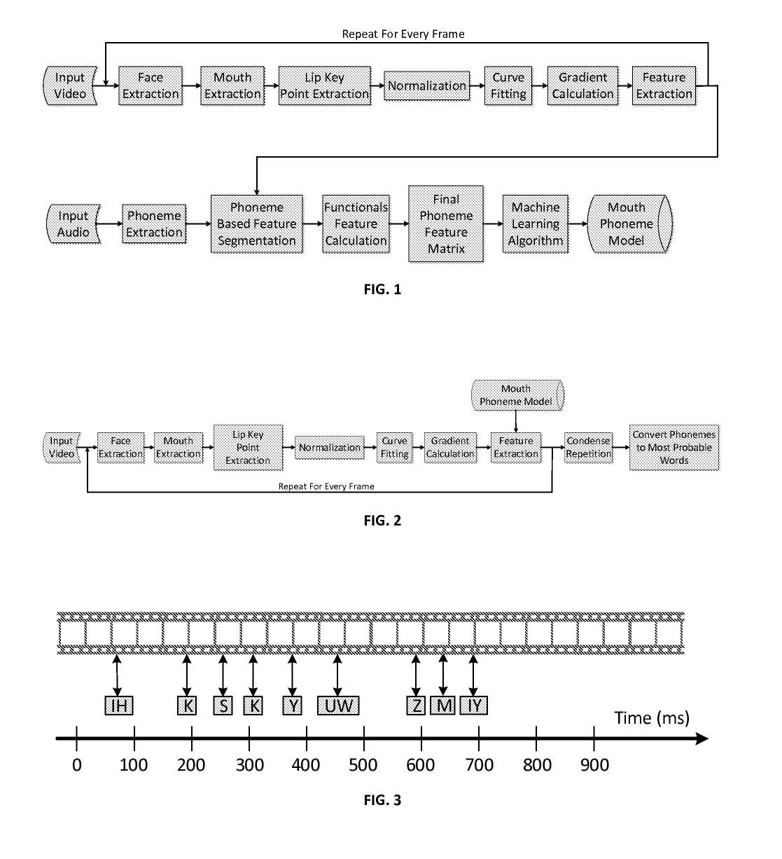

FIG. 1 illustrates the training process of the lip reading system, which involves inputting a video from a camera, followed by detecting the speaker's mouth, and eventually a series of features are extracted from the speaker's mouth ROI. This process is repeated for every frame, and once complete, audio data from the same video is extracted. A mouth-phoneme model is created by relating the visual characteristics of the speaker's mouth with the corresponding spoken phonemes.

The first step of the lip reading algorithm involved breaking videos from input video into individual frames, essentially images played over time. Within each individual frame, the speaker's face was detected using a face classifier, a standard image processing method. Once the speaker's face had been identified, a mouth classifier was used to identify the mouth region of interest (ROI).

The mouth region of interest includes both desirable and undesirable information. In order to better distinguish the speaker's lips from the surrounding area, frames were converted from the RGB color space to the Lab color space. Normalized luma and hue were used to identify the speaker's lips, and, furthermore, key points that could be placed to model the speaker's lip movements over time, the most vital part of the lip reading algorithm. Identifying proper key points allows for accurate numerical feature extraction, without which computerized lip reading would not be possible.

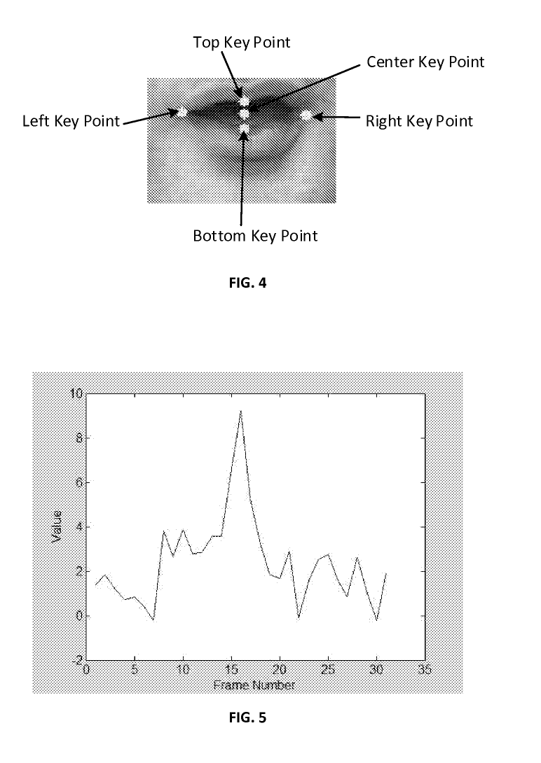

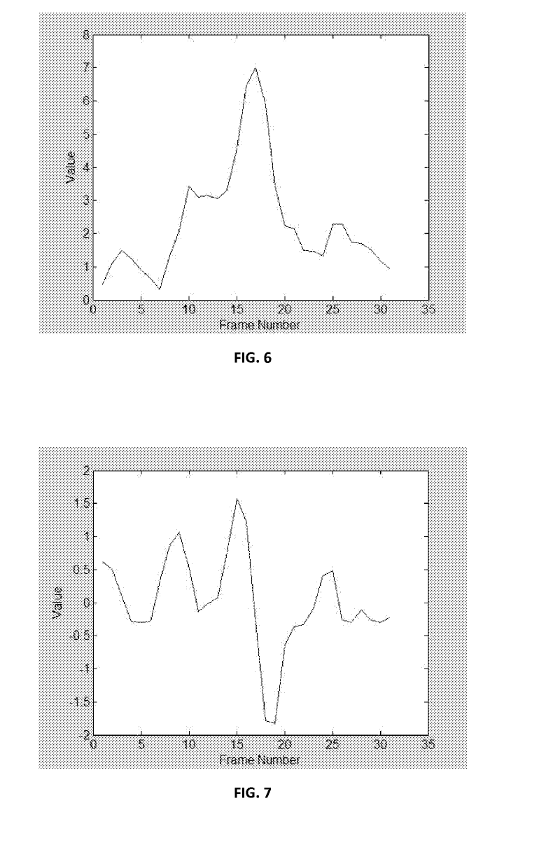

Following lip segmentation, key points were identified and placed in the left, right, top, and bottom parts of the inner lip, as shown in FIG. 4. These points were selected as they are more representative of human speech in comparison to points on the outer lip.

In cases where the speaker's mouth was at an angle relative to the horizontal, normalization was used to rotate the key points to a horizontal orientation.

As shown in FIG. 9 and FIG. 10, the dot product of the lip and horizontal vectors were used to calculate the compensation angle. A scale factor was also applied to the lip key points in order to maintain the aspect ratio.

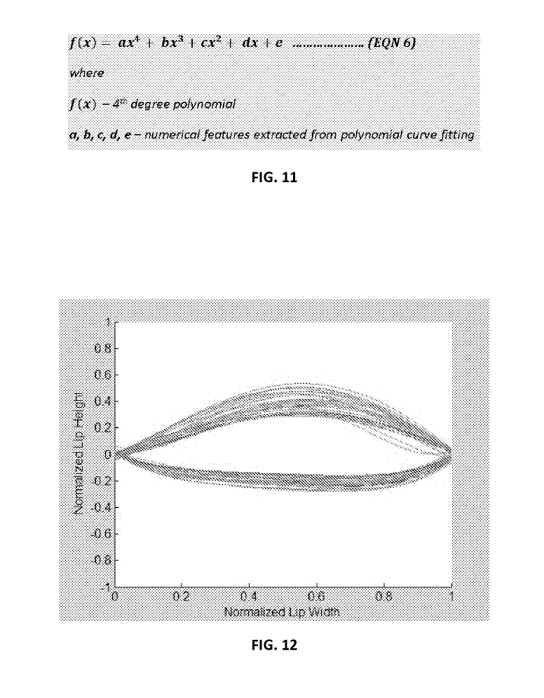

In addition to key point extraction, polynomial curves of the speaker's lips were implemented in MATLAB, as shown in FIG. 11, in order to provide more information needed for accurate speech recognition. Polynomial curve fitting allows for modeling of lip curvature, a characteristic which changes for each viseme as shown in FIG. 12.

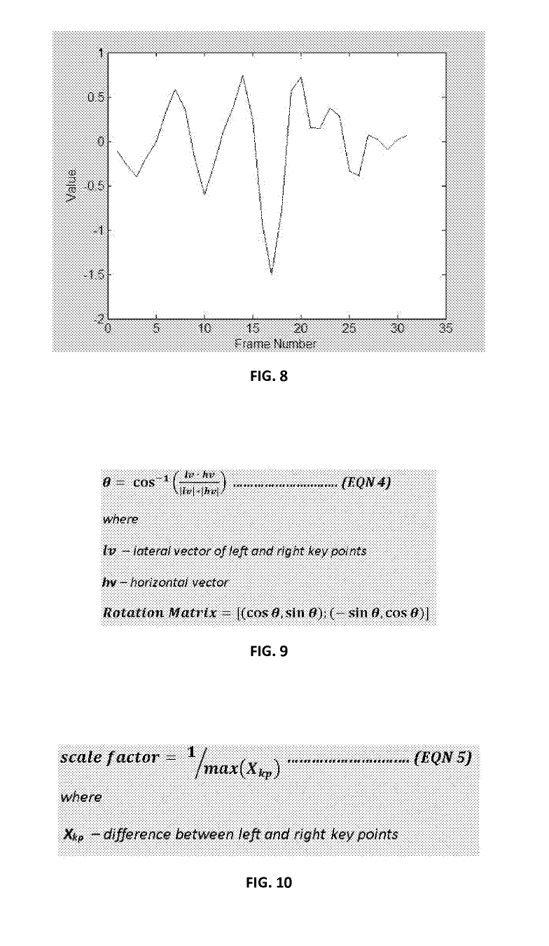

The next set of features that were extracted are the gradients. MATLAB was used to compute the 0^{th}, 1^{st}, and 2^{nd} gradients after smoothing using a 3-tap moving average filter as shown in FIG. 6, FIG. 7 and FIG. 8 respectively. Gradients show how much and how fast the speaker's lips change over time.

The last set of features includes the minimum, mean, maximum and standard deviation of the lip key points over the frames.

A total of 60 features are extracted using 5 coefficients computed by the polynomial curve fitting, 3 gradients of features that were extracted from lip key points, and 4 functionals that were extracted also from lip key points.

Mouth-Phoneme Model

Current lip reading research involves using only visual information to lip read. This invention developed a lip reading system that is based off of a model that relates phonemes to visemes in a unique way, which allows for direct conversion of a speaker's lip movements to phonemes, the components of words.

As shown in FIG. 3, we extract phonemes from the corresponding audio information and their timestamps using SAPI 5.4. Subsequently, we look at the features of the mouth ROI at that timestamp and look at features two frames before the current one as well as two frames after. The reason why it is done this way is because phonemes span over multiple frames. Phonemes arte then tagged with the corresponding visual characteristics of the mouth ROI at that time. This operation is done for every frame.

A machine learning algorithm was used in order to train the lip reading system. Machine learning algorithms find trends and patterns in a set of data. By training the mouth-phoneme model, stronger and more accurate phoneme predictions can be made by the lip reading system when given a series of lip movements.

After phonemes are predicted by the mouth-phoneme model, SAPI 5.4 is used again to convert phonemes into words, as well as predict common word sequences in the English language based off of contextual information.

1. What we claim as our invention is the design of a mouth phoneme model that allows efficient extraction of phonemes and visemes from an audio and video database of people pronouncing various English words and applying this methodology to a lip reading system to achieve high accuracies.
